(19) United States
(12) Patent Application Publication
(10) Pub. No.: US 2006/0275569 A1
(43) Pub. Date: Dec. 7, 2006

(54) Thermoplastic molding material for electronic packaging

(76) Inventors: Sanjay Braj Mishra, Evansville, IN (US); Yuxian An, Shanghai (CN); Fangming (Tony) Gu, Shanghai (CN); Yong She, Shanghai (CN)

Correspondence Address: GEAM - O8CV - CPP;IP LEGAL, ONE PLASTICS AVENUE, PITTSFIELD, MA, 01201-3697, US

(21) Appl. No.: 11/284,352

(22) Filed: Nov. 21, 2005

Related U.S. Application Data
(60) Provisional application No. 60/682,144, filed on May 18, 2005.

(51) Int. Cl. B32B 27/08

(52) U.S. Cl. 428/35.7

(57) ABSTRACT

A thermoplastic composition comprising a polyethylene terephthalate having chemically incorporated within the polyethylene terephthalate a) crystallinity reducing amount of an isophathalic acid, or a crystallinity reducing amount of diethylene glycol, or a crystallinity reducing amount of a combination of an isophathalic acid and diethylene glycol thereby making a modified polyethylene terephthalate; b) a chain extending agent which has reacted with a carboxy end group or an alcohol end group, and c) an amount of at least one antiblocking agent that maintains the neck opening of a parison formed from the composition, the parison surrounding a capacitor.

### CROSS REFERENCE TO RELATED APPLICATIONS

This application claims priority to U.S. Provisional Application Ser. No. 60/682,144 filed on May 18, 2005, which is incorporated herein by reference in its entirety.

### BACKGROUND OF THE INVENTION

The utilization of engineering plastics for electronic packaging is desirable. The performance characteristics of engineering plastics can be significantly changed through appropriate alterations of structure, blends with other polymers, additions of stabilizers, additives, and the like. However, most of the time there is a price to be paid. For a “general” enhancement of properties or a more focused enhancement of a single property or even several properties, there is often a lowering of one or many other properties so that the composition can no longer perform its intended purpose. There is no formula, which can generally predict the effect of new components in a composition. Results can be surprising from a positive or negative direction.

Polyesters are known to be highly crystalline materials in their solid form. This is usually quite inhibiting to blow molding since the crystalline materials, such as polyethylene terephthalate (PET) and polybutylene terephthalate (PBT) cannot expand properly, but rather break.

Desirable properties for thermoplastic packaging material include actually maintaining melt strength sufficiently so that the material does not crack or break when it is expanded. Moreover, it is desirable for the same composition to be contracted substantially upon heating so that it provides a film around a very small object, such as a micro-capacitor used in electronic equipment, without significant physical or chemical degradation.

### SUMMARY OF THE INVENTION

In accordance with the invention there is a molding material composition comprising a polyethylene terephthalate,

a. having chemically incorporated within the polyethylene terephthalate a crystallinity reducing amount of an isophthalic acid, or a crystallinity reducing amount of diethylene glycol, or a crystallinity reducing amount of a combination of an isophathalic acid and diethylene glycol thereby making a modified polyethylene terephthalate,

b. having chemically incorporated in the modified polyethylene terephthalate a chain extending agent which has reacted with a carboxyl end group or an hydroxyl end group, and

c. having in the composition an amount of at least one anti-blocking agent that maintains the neck opening of a parison formed from the composition, the parison surrounding a capacitor.

### BRIEF DESCRIPTION OF THE DRAWING

FIG. 1. shows an electronic component in the form of a capacitor with lead wires and having a protective coating.

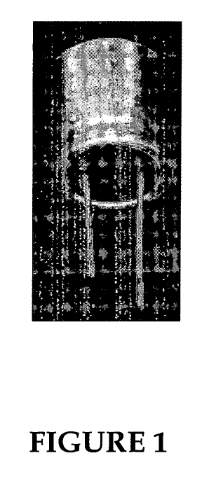

### DESCRIPTION OF THE INVENTION

The composition of this invention can meet the rigorous requirements of an industry which requires high temperature stability and mechanical properties of protective coverings with additional requirements of great strength and flexibility in their final protective covering application. Still further the method of coating needs both an expansion and a contraction of a thin covering which has memory as well as all the final characteristics previously noted. A specific application of this inventive composition is the coating of a capacitor(s) utilized in computer(s). The purpose of the polyester film is to provide insulation and to protect the surface from insults such as humidity and various chemicals, for example keytones, glues, adhesives and the like. The film covers all the capacitor sides. With respect to the top and the bottom, the film covers as much as is necessary to satisfy the function of the coating. It is important that the film not extend beyond the side of the capacitor at the same angle as the sides of the capacitor. That is, the film should be folded in and contact the top and the bottom of the capacitor to at least a limited extent.

Such coated capacitor can be used in applications as computers, printed circuit boards, transistors, and any type of separate electronic component.

The film should be essentially the same thickness around all parts of the capacitor including the top and the bottom. There should be no kinks or breaks in the film at any point, particularly at the top or bottom of the capacitor. There should be no film turn up at top or bottom and the film should have a tight adherence to the substrate upon heat aging at 180° C. for 30 minutes and 105° C. for two hours. The side film surface should have no dimple, dent, wrinkle or unevenness after heating at both 180° C. for 30 minutes and 105° C. for two hours.

The capacitor is usually made of aluminum or any other light metal or alloy thereof which can perform as a capacitor. The general dimensions of a capacitor for example 40×70 mm or even larger up to 150×250 mm, or even higher (width by height)are such that the film covering must be highly flexible while retaining its overall strength and mechanical characteristics during cooling and “shrinking” around the capacitor.

The basic resin employed in the composition is a polyethylene terephthalate (PET). In order to properly perform the desired application, the PET is modified. Introduction of isophthalic acid (IPA) and/or diethylene glycol (DEG) within the PET chain during preparation of the PET is employed. Although not understood, it is believed that interrupting the crystallinity of the PET is helpful in successfully achieving the encapsulated capacitor.

The amount of IPA employed is a minimum of about 1.0 mole %, preferably about 1.5 mole % of the terephthalate. Below about 1.0, difficulty in expansion occurs. If the IPA level is too high, a high intrinsic viscosity (I.V.). cannot be readily obtained. A maximum IPA level is about 6 mole %, preferably about 5 mole %. For purposes of capacitor encapsulation, a DEG level which is too low will bring about surface defects in the application. If the DEG level is too high, an appropriately high I.V. is difficult to obtain. Generally a minimum level of DEG is about 1.0 mole % of diol, preferably about 1.5 mole %. A maximum level of DEG is about 6.0 mole %, preferably about 5.0 mole %. When DEG and IPA are used together the maximum is about 7 mole %, preferably about 6 mole % together of the DEG and IPA. The IPA and/or DEG are incorporated into the PET by well known methods during the synthesis of the PET. DEG is commonly present in PET as an unwanted but normal constituent in quantities up to somewhat lower that about 1 mole % of total diol.

The modified PET as previously described is of high intrinsic viscosity. Generally a minimum I.V. is about 0.75 preferably about 0.78. A maximum I.V. is about 0.90, preferably about 0.87 as measured in phenol/tetrachlorethane 60:40 by wt at about 25° C. Below about 0.75 the PET is very difficult to expand, probably because the melt strength is too low. Above an I.V. of about 0.90 there is too much crystallinity in the virgin pellets to comply with the previously noted application because of processing difficulties.

During both compounding and tube-forming processes, there is usually a severe thermal degradation leading to a significant drop in intrinsic viscosity of PET. In order to make PET blow-moldable and the formed tube with excellent mechanical properties, its molecular weight needs to be built up. This can be accomplished by using the active chain end groups of the PET. As opposed to other polymers such as polycarbonates the typical preparation of PET does not involve an end capping agent but rather prepares a “living” polymer; that is, the polymer segments have a reactive moiety at each end. In the case of PET this is an aromatic carboxy group and/or an aliphatic hydroxyl. These groups are reactive with a polyfunctional agent so as to connect separate PET strand(s) into a single or multiple strands thereby providing a higher I.V. to the composition.

Any polyfunctional reactive material can be used for the treatment of the modified PET. These can be either polymeric or non-polymeric. Examples of reactive groups include epoxides, carbodiimides, orthoesters, oxazolines, oxiranes, aziridines, and anhydrides. The reactive material can also include other functionalities that are either reactive or non-reactive under the described processing conditions. Non limiting examples of reactive moieties include reactive silicone containing materials, for example epoxy modified silicone monomers and polymeric materials. If desired, a catalyst or co-catalyst system can be used to accelerate the reaction between the polyfunctional carboxy-reactive material and the modified polyester. The term “poly” means at least two reactive groups.

Particularly useful reactive moieties for treatment of the modified PET include materials with more than one reactive epoxy group. The polyfunctional epoxy compound may contain aromatic and/or aliphatic residues. Typical examples used in the art include 3,4-epoxycyclohexylmethyl-3,4-epoxycyclohexanecarboxylate, epoxy novolac resins, epoxidized vegetable (soybean, linseed) oils, and styrene-acrylic copolymers containing pendant glycidyl groups.

Preferred materials with multiple epoxy groups are styrene-acrylic copolymers and oligomers containing glycidyl groups incorporated as side chains. Several useful examples are described in the International Patent Application WO 03/066704 A1 assigned to Johnson Polymer, LLC, incorporated herewith. These materials are based on oligomers with styrene and acrylate building blocks that have desirable glycidyl groups incorporated as side chains. A high number of epoxy groups per oligomer chain is desired, at least about 10, preferably greater than about 15, and more preferably greater than about 20. These polymeric materials generally have a molecular weight greater than about 3000, preferably greater than about 4000, and more preferably greater than about 6000. These are commercially available from Johnson Polymer, LLC under the Joncryl® trade name. Preferably, Joncryl® ADR 4368 is used.

These agents provide a higher molecular weight I.V. to the PET and introduce significant branching into the PET. These agents are not monomers in the PET synthesis but rather link one end of a PET strand to an end of a second PET strand. The process of accomplishing this result is through the reaction of an already synthesized PET, for example, in the melt, with the noted agent. Catalysts can be employed if needed and/or desired. The reaction can occur in any convenient reactor or an extruder during the compounding of the composition.

The quantity of such an agent is that amount which increases the I.V. sufficiently so that a stable parison can be readily prepared by extrusion. Quantities can vary from about 0.05 wt % of the PET to about 1.2 wt % of the PET. Below about 0.05 wt % there is generally too much degradation of the PET polymer during its own compounding or difficulty in preparation of a parison. Above about 1.2 wt % there is a “recovery” problem of the composition which can result in not accomplishing the desired encapsulation of the capacitor. Preferred minimums are about 0.1 to about 0.2 wt % of the PET. In general, the agent assists in maintaining the integrity, i.e. the molecular weight of the PET during processing of itself and the desired application of encapsulating a capacitor.

As stated previously the overall surrounding, encapsulation, of the capacitor is extremely difficult to achieve. One of the difficult problems to overcome is the collapsing of the parison around the top and/or bottom of the capacitor prior to successfully shrink wrapping the film about the capacitor. It has now been discovered that the addition of at least one antiblocking agent to the composition allows the composition to be successfully shrink wrapped about the top and the bottom of the capacitor. An antiblocking agent is a material that prevents sheets of tightly wound plastic rolls of film, such as polypropylene, from sticking to each other. By using appropriate quantities of an anti-blocking agent the collapsing of PET film at the top and/or the bottom of the capacitor can be sufficiently inhibited so that successful shrink wrapping can appropriately occur around the top and/or bottom of the capacitor at the proper time

Although the above paragraph and limitation (c) of the claims relate to appropriate shrink wrapping around the top and/or the bottom of a capacitor, the applications of the application and the breadth of the claims are not limited to this one application. Rather the composition should have the ability to accomplish this step if a parison is made from the composition.

The examples of anti-blocking agents include minusil, calcium carbonate, silicone oils, lithium stearate, clay(s), glass microbeads and the like. Preferred for usage are micro fine silicone resins such as Tospearl,® available from General Electric Company, in tightly controlled particle sizes which allow for faster processing (extrusion rates) and improved quality of the composition.

The antiblocking agent is incorporated into the composition through its usual method, i.e. during the compounding, i.e. finishing operation. The appropriate quantities depend upon the specific anti-blocking agent employed and are consistent with the manufacturer's prescribed amount. For example, a silicone oil is used in quantities of about 0.1 to about 2 wt. % of the composition while Tospearl® is from about 0.2 to about 1.0 wt. % of the composition.

The composition of the present invention may include additional components that do not significantly interfere with the previously mentioned desirable properties but enhance other favorable properties such as antioxidants, colorant, including dyes and pigments, lubricants, mold release materials, nucleants or ultra violet (UV) stabilizers. Examples of lubricants are alkyl esters, for example pentaerythritol tetrastearate, alkyl amides, such as ethylene bis-stearamide, and polyolefins, such as polyethylene.

It is through a combination of these modifications of the basic polymer and the addition of the antiblocking agent(s) that the successful encapsulation of a capacitor can occur. Of course the composition can be successfully employed for any other application as well, particularly those that require extreme flexibility, processing stability, maintenance of physical characteristics, lack of brittleness and the like. Examples of such applications include connector for wire and cable, packaging film, corrosion-proof tube and the like.

Processing Methods

(A) Method of making the modified polyester:

In a general synthesis utilized for making a PET, a sufficient amount of IPA and/or DEG is added together with the usual terephthalate precursor and ethylene glycol precursor to prepare the modified PET having the desired quantities of IPA and/or DEG.

(B) Preparing the final composition:

Using the PET made in A above, the ingredients of the examples shown in the table below, were tumble blended and then extruded on a co-rotating 37 mm Toshiba Twin Screw Extruder with a vacuum vented mixing screw, at a barrel and die head temperature between about 260 and about 280° C. and 300 rpm screw speed. A 100 mesh or above screen pack was generally used to keep the material clean. The extrudate was cooled through a water bath and then pelletized.

(C) Method(s) of making heat shrink tube and capacitor coating:

The compounded PET pellets of part B were dried sufficiently in a forced air-circulating oven. The water content was kept less than 0.01%. The dried pellets were then added through a hopper to a 35 or 45 mm single screw extruder where they were conveyed, plasticized and metered by heating the material in the temperature range above the melting point of PET but below its thermal decomposition temperature. An O-ring type die head with a specific slit thickness was equipped at the end of the extruder. By using compressed air flowing through the ring die, the PET melt was extruded and blow molded to form a hollow tube. Shortly after the departure from the ring die, the tube was then quenched in the cooled circulating water to freeze the shape in a certain original diameter. This was called the 1^{st} setting of the tube (undrawn stage).

The undrawn tube was then passed through a vacuum chamber to remove water on the surface. The dried, undrawn tube was heated by either infrared heater or hot water to facilitate the smooth expansion and stretching. Compressed air was used to expand the tube in the radial direction. Simultaneously, the tube was also stretched in the lengthwise direction by rotating two rolling pans at different speeds before and after drawing. Immediately after the biaxial stretching, the drawn tube was quenched again by dipping into cooling water to fix the draw ratio at predetermined values.

Usually, the draw ratio was kept in the range of 1.5-2.5 and 1.01-1.2 times in the radial and lengthwise direction, respectively. The above biaxial stretching was called the 2^{nd} setting of the tube (drawn stage). With help of a pair of rolling pans, the tube was pressed flat and wound into a roll. After secondary operation, if employed, such as surface printing, the roll of drawn tube was ready for capacitor coating.

(D)Coating the Capacitor:

The general method of coating the capacitor is simply to apply heat to the drawn tube inside which the naked capacitor is inserted. The heating temperature is usually set at 250+/−50° C. for a fraction of second. The tube is then shrunk instantly in both radial and lengthwise direction simultaneously to give a tight wrap outside the capacitor, thereby providing a coating around such capacitor.

Method of successful application and comparative example(s) showing unsuccessful application of parison film to capacitor:

Below are comparative examples, 3-6, showing inadequate film production and coating when parameters are outside the claimed invention and successful production, examples 1-2, when the inventive composition is used. The following symbols are employed: O is successful, x is unsuccessful

| | | | | Comparative | | | | | |
|---|---|---|---|---|---|---|---|---|---|
| | | Example | | example | | | | | |
| Composition | Unit | 1 | 2 | 3 | 4 | 5 | 6 | 7 | 8 |
| co-PET-1 | wt.-% | 100 | 100 | | | 100 | 100 | 100 | 100 |
| co-PET-2 | wt.-% | | | 100 | | | | | |
| co-PET-3 | wt.-% | | | | 100 | | | | |
| Chain extender | wt.-% | 0.5 | 0.5 | 0.5 | 0.5 | — | 0.5 | 0.5 | 0.5 |
| Anti-block agent | wt.-% | 0.2 | 0.2 | 0.2 | 0.2 | 0.2 | — | 0.2 | 0.2 |
| External lubricant | wt.-% | 0.2 | 0.2 | 0.2 | 0.2 | 0.2 | 0.2 | — | 0.2 |
| Nucleant | wt.-% | 0.2 | — | 0.2 | 0.2 | 0.2 | 0.2 | 0.2 | 0.2 |
| Colorant package | wt.-% | 0.2 | 0.2 | 0.2 | 0.2 | 0.2 | 0.2 | 0.2 | — |

Property

| | | | | | | | | | |
|---|---|---|---|---|---|---|---|---|---|
| Pcrocess ease | — | ◯ | ◯ | X | ◯ | ◯ | ◯ | X | ◯ |
| Blow moldable & | — | ◯ | ◯ | ◯ | X | X | ◯ | ◯ | ◯ |
| Expanda [symbol] | | | | | | | | | |
| Heat resistant - A | — | ◯ | ◯ | X | ◯ | ◯ | ◯ | ◯ | ◯ |
| Heat resistant - B | — | ◯ | ◯ | ◯ | X | X | ◯ | ◯ | ◯ |
| Slipperyness | — | ◯ | ◯ | ◯ | ◯ | ◯ | X | X | ◯ |
| No transparency | — | ◯ | ◯ | ◯ | ◯ | ◯ | ◯ | ◯ | X |

co-PET-1: components comprising of terephthalic acid 97.2 mol %, isophthalic acid 2.8 mol %, ethylene glycol 98 mol % and diethylene glycol 2 mol %; I.V. = 0.81
co-PET-2: components comprising of terephthalic acid 100 mol %, ethylene glycol 98.9 mol % diethylene glycol 1.1 mol %; I.V. = 0.99
co-PET-3: components comprising of terephthalic acid 100 mol %, ethyleneglycol 98.6 mol % diethylene glycol 1.4 mol %; I.V. = 0.64
Chain extender: Joncryl ADR 4368 Styrene-acrylate-epoxy oligomer
Anti-block agent: Tospearl B2000 and Silicate
Heat resistant - A: tube side surface has no dimple, dent, wrinkle and unevenness upon heating at both 180 deg C./30 min and 105 deg C./120 min
Heat resistant - B: tube top and bottom surface has no film turn up and film should have a tight adherence to metal substrate upon heat ageing at both 180 deg C./30 min and 105 deg C./120 min

1. A composition comprising a polyethylene terephthalate
a. having chemically incorporated within the polyethylene terephthalate a crystallinity reducing amount of an isophathalic acid, or a crystallinity reducing amount of diethylene glycol, or a crystallinity reducing amount of a combination of an isophathalic acid and diethylene glycol thereby making a modified polyethylene terephthalate,
b. having chemically incorporated in the modified polyethylene terephthalate a chain extending agent which has reacted with a carboxyl end group or a hydroxyl end group,
c. having in the composition an amount of at least one antiblocking agent that maintains the neck opening of a parison formed from the composition, the parison surrounding a capacitor.

2. The composition in accordance with claim 1 wherein the chain extending agent reacts with a carboxy acid.

3. The composition in accordance with claim 2 wherein the agent is a multi epoxy containing polymer.

4. The composition in accordance with claim 1 wherein a crystallinity reducing amount of an isophthalic acid is chemically incorporated within the polyethylene terephthalate.

5. The composition in accordance with claim 1 wherein a crystallinity reducing amount of diethylene glycol is chemically incorporated within the polyethylene terephthalate.

6. The composition in accordance with claim 1 wherein a crystallinity reducing amount of a combination of isophthalic acid and diethylene glycol is chemically incorporated within the polyethylene terephthlate.

7. The composition in accordance with claim 2 wherein the amount of chain extending agent is from about 0.2 to about 1.2 wt. % of the polyethylene terephthlate.

8. The composition in accordance with claim 4 wherein the isophthalic acid is about 1.0 to about 6 mole % of the acid in the polyethylene terephthalate.

9. The composition in accordance with claim 5 wherein the diethylene glycol is about 1 to about 6 mole % of the diol in the polyethylene terephthalate.

10. The composition in accordance with claim 1 wherein the anti blocking agent is a silicone or silicate.

11. The composition in accordance with claim 9 wherein the anti blocking agent is at least one micro fine silicone resin.

12. An article blow molded from the composition of claim 1.

13. A capacitor coated with the composition of claim 1.

14. The capacitor of claim 13 which is a micro-capacitor.

15. An object coated with the composition of claim 1.

16. An object molded from the composition of claim 1.
